(19) United States
(12) Patent Application Publication
(10) Pub. No.: US 2010/0051557 A1
(43) Pub. Date: Mar. 4, 2010

(54) HEAVY METAL CATIONS ELIMINATION FROM AQUEOUS MEDIA BY NANOTECHNOLOGY

(75) Inventors: Seyed Gholamreza Etemad, ISFAHAN (IR); Rooholah Yadavi, ISFAHAN (IR)

Correspondence Address: BARRY CHOOBIN, TALEGHANI, BAHARE SHOMALI , #219, SUITE#18, TEHRAN, 1563714311, IR

(73) Assignee: ISFAHAN UNIVERSITY OF TECHNOLOGY, ISFAHAN (IR)

(21) Appl. No.: 12/616,287

(22) Filed: Nov. 11, 2009

(51) Int. Cl. C02F 1/62; C02F 1/48; C02F 1/42

(52) U.S. Cl. 210/688; 210/695

(57) ABSTRACT

Disclosed is a process, which is used to eliminate heavy metal cations from the aqueous media, and provides a better solution for the existing problems of the separation systems like low efficiency and high costs. The heavy metal cations selected for this purpose are cadmium, lead and copper. The separation system consists of a two stage process: In the first stage, the iron oxide nanoparticles are suspended in an aqueous medium contaminated with the heavy metal cations. In the second stage, the solution is brought into contact with a ferromagnetic matrix (or a paramagnetic matrix) magnetized by the application of an outside magnetic field. The heavy metal cations are deposited on the matrix under the imposed magnetic field. This two-stage process makes it possible to separate the heavy metal cations from the aqueous medium. The wire matrices are upon the completion of separation washed away by water or air current.

### BACKGROUND OF THE INVENTION

1. Field of Invention

This invention related to eliminate of heavy metal cations from aqueous media. Heavy metals such as lead, nickel, cadmium, chromium, copper, iron, zinc, manganese and mercury in high concentrations are extensively used in various industrial processes, and especially iron and steel industries contain heavy metals. These elements have very toxicological properties, aggregation susceptibility and stability even in low concentrations. The present invention related to use the two properties of magnetite nanoparticles simultaneously (high adsorption capacity and superparamagnetism) for elimination of metal cations from aqueous media. The heavy metal cations selected for this purpose are cadmium, lead and copper. This method is extendable for other heavy metal cations with oxidation number +2 and +3 whereas the nanoparticles are super paramagnetic iron oxide (Fe₃O₄).

2. The Relevant Technology

The importance of subject and tremendous effects of water in terms of the economic, social and cultural life of nations are evident and need no elaboration. However, as a result of lack of attention to this crucial issue, the water resources of the earth are faced with destruction and annihilation. Water as a solvent dissolves the substances when it comes in contact with them and carries the small and suspended particles with itself, therefore the water cycle in industry possesses weak quality upon the addition of impurities. On the other hand failure to consider principles and criteria and non-domestication of urban and industrial sewage end up with not only the loss of effluent but with the severe contamination of many water sources. Heavy metals are major and dangerous contaminants that their concentration in the environment raises in direct proportion with the expansion of cities and development of industries. As a result of the exploitation of resources and mines on the whole world as well as the technological activities, heavy metals contaminate water through soil, air and effluent and are considered a leading category of contaminants. Indeed, the excessive concentration of these elements is a token to the contamination of water with the industrial sewage. It is to be noted that by definition heavy metals are that category of chemical elements the density of which is over 3 gr/cm³. These elements are located in the central part of periodic table and are called transition metals. These are available in the environment in free occurring, oxide, sulfide and other forms. Heavy metals are extensively used in various industrial processes and the effluents of the different industries like mining, metallurgy, papermaking, leather making, plastic, photography, electronic, chemical, fertilizer and especially iron and steel industries contain heavy metals such as lead, nickel, cadmium, chromium, copper, iron, zinc, manganese and mercury in high concentration. These elements are very important due to their toxicological properties, aggregation susceptibility and stability even in low concentrations. Even if not used directly in the industry, they can be present in the form of impurity in raw materials. Only small and insignificant portion of these metals are separated via the physical and chemical treatment processes (the physicochemical treatment plants usually demand high costs in terms of construction, maintenance and raw material procurement) and in the vast majority of cases there is no plant dedicated to the separation of heavy metals, therefore effluent carries considerable amount of these contaminants and brings about the secondary contamination of the ground and underground water. Nowadays the information of the consumers and industrial owners with the matter and the secondary pressures of the governments to prevent these contaminants are on the increase. Many of the heavy metals are toxic and their presence in the aqueous and earth sources beyond the safe limits bring about disorders like poisoning, carcinogenesis and genetic mutations in the short and long runs. The most important effect of these elements on the human body is their effect on the enzymes. The presence of these elements in ionic form in water deteriorates the activity of the enzymes and can increase, decrease or even make it impossible. On the other hand, the presence of these elements in abnormally concentration exerts a destructive effect on the life of animals and plants and if they enter food chain, they are not decomposable and their concentration keeps increasing. Recently more of these heavy metals have entered the environment in high concentrations and the application of suitable methods to eliminate them is a very important task.

We can refer to reverse osmosis, permeation process, chemical precipitation, surface adsorption and iron exchange resins as the most important methods that have been used in recent years. These methods were neither efficient nor economical especially where the concentrations of cations are in the range of 1-100 ppm. Also, complicated and huge equipment were needed for these methods. It seems that despite of overcoming such problems, because of formation of a large amount of secondary wastewater, these methods have not been efficient. Results of different research shows that none of the mentioned methods has simultaneously provided the two important factors in the separation (high efficiency and low cost) [(Resour. Conserv., Vol. 14, pp. 71-92, 1987), (Chem. Soc. Rev., Vol. 31, pp. 60-67, 2002)].

Researches have been done using reverse osmosis method by investigators such as Ozaki and Sharma (Desalination, Vol. 144, pp. 287-294, 2002). This method is not economical for the processes with high metal concentrations. Therefore, other methods such as biological adsorption or ion exchange most be employed for elimination of heavy metals.

Permeation process has been tested as a method of separation by researchers such as Urtiaga and others (Indian J. Eng. & Mater. Sci., ences, Vol. 8, pp. 194-201, 2002). In a successful permeation process, the concentration of metals in the feed must be in an acceptable low level. As the concentration increases, the cost of process increases and the efficiency decreases. Also in this process, some quantities of undesired cations might permeate through the membrane. On top of that, the membranes have short life and are expensive. They cannot resist against chemical variation and pH fluctuation. Also in the presence of microorganism, they lose their quality.

In the chemical precipitation methods, the metals usually settle in the hydroxide or sulphide forms. In many cases, the presences of some elements in solution make the case inefficient and increase the consumption of chemicals. At the same time, the quality of water is not good enough to be used again. A two-step chemical precipitation process involving hydroxide precipitation and sulfide precipitation combined with field separation technology such as magnetic separation, dissolved air flotation employed by Steven L. Cort (U.S. Pat. No. 7,255,793 B2, Aug. 14 2007).

Research on surface adsorption has been done by Lang and Kunze and many other researchers (Desalination, Vol. 157, pp. 97-104, 2003), (Journal of Hazardous Materials, Vol. 143, pp. 569-578, 2006). In this separation method, different absorber such as biological, silica gel, activated carbon, charcoal ash, zeolite and the mineral wastes has been used. The activation step and used carbon regeneration are the expensive processes. After each activation process, the adsorber mass decreases and the adsorption capacity reduces by 10-15 percent, which cause higher process cost.

Ion exchange resins have been extensively used in heavy metals elimination, but there are some limitations in this process. For example chemical and physical resistance, lifetime and ion exchange behavior should be considered in each process. These resins are not heat resistant. The adsorption capacity would be affected by cu²⁺ and mg²⁺. Koopman et al. (Hazard have done some researches in this respect. Mater, Vol. 81, pp. 173-181, 1999).

Among all the registered invention, U.S. Pat. No. 6,596,182 B1 (which has been registered on 22 Jul. 2003) is similar to this work but the inventors claimed to remove of heavy atoms from water via in situ formation of magnetite to the water.

The proposed method in this invention makes the separation of heavy metals with high efficiency and at the same time the recovery of these particles is possible so it makes the whole process economical in comparison to other methods. With the extension of nanotechnology applications and increasing in the market share of nanoparticles, this separation method would become the chipset process in future.

### SUMMARY OF INVENTION

In consideration of the new global water crisis, it is evident that the water treatment is one of the major issues for the application of nanotechnology in water industry. It is hoped that its utilization will reduce the water treatment costs to a great extent and the problem of elimination of heavy metals from effluent is solved by the application of nanotechnology.

This invention is based on the combination of two separation techniques namely adsorption and magnetic capturing through a two stage process: in the first stage the magnetic nanoparticles are suspended in the aqueous media contaminated with the heavy metal cations and adsorb the contaminants. In the second stage, the solution, which contains nanoparticles impregnated with the heavy metal cations, is brought in contact with a ferromagnetic matrix (or a paramagnetic matrix) magnetized by using of an outside magnetic field. Based on this two-stage separation process, the metal cations are separated from the aqueous medium and subsequently washed away from the wire matrices by a flow of water or air. The capturing efficiency of the magnetized particles, in this separator, depends on numerous factors: superficial velocity of the suspension containing the nanoparticles, the amount of the material captured on the matrix, nature and geometric specifications of the matrix, the direction of the magnetic field applied, nature of the suspension as well as the physical and magnetic properties of the particles suspended in the solution.

Among the magnetic particles, super magnetic iron oxides are mostly used because of their chemical stability and adaptability. The magnetite (Fe₃O₄) nanoparticles in the room temperature show super paramagnetic behavior and are highly magnetized under the influence of a magnetic field. However this magnetism is not permanent and disappears with the elimination of the magnetic field.

The structural form of the magnetite nanoparticles is FeO.Fe₂O₃, which makes the metal cations easily substituted with iron cations in the magnetite molecule. In the event the cations in the aqueous medium have +2 oxidation number (M²⁺) they will substitute in the magnetite molecule under the form of MO.Fe₂O₃ while in case of +3 oxidation number (M³⁺) they will substitute under the form of FeO.FeMO₃. In the other words the adsorption process causes that a heavy metal cation enters in iron oxide molecule structure and exchange in to atomic form. At the same time an iron atom enters in solution in cationic form. This ion exchange has been studied and confirmed with results of atomic absorption spectroscopy experiments. As this instrument can report only the concentration of metals in ionic form, the reduction of cations concentration can be calculated. In the meantime, this equipment can calculate the iron cations concentration after adsorption process and compare with reduction of heavy metal cations concentration in solution (as a heavy metal cation enters in solution, an iron cation exits from magnetite molecule structure and enters in solution). The results confirm ion exchanging as the adsorption mechanism process. As we know, the results of magnetic separation show percentage of nanoparticles, which captured by magnetic field, so multiplication of results (from step 1 and 2) shows amount of heavy metal cations, which remove with this separation mechanism.

As far as the adsorption of metal cations by the nanoparticles is concerned, pH is a highly important factor because it controls the surface charge density of these particles and is considered a key parameter for the adsorption process. In the case with point of zero surface charge density, pH depends on the type of nanoparticles synthesis as well as degree of their purity. In addition to the surface charge density, the chemical nature of the nanoparticles and the metal cations are highly dependent to pH. Any increase in pH brings about the chemical precipitation of the metal cations whereas any decrease causes the dissolution of the nanoparticles. The rate of this process (the dissolution of the nanoparticles as a result of the decrease in pH) increases with the temperature increase. The above-mentioned points indicate that there is a narrow range of pH where the absorption can take place satisfactorily.

The contact time of the nanoparticles with the metal cations during the adsorption stage is a very important factor. The size and particle size distribution are major characteristics of the nanoparticles, too. These two characteristics severely affect the colloid parameters of the particles, which are among their most important features. Among these, more important parameters are the theology and specific area of the particles. In order to prevent the aggregation of nanosized particles which give rise to larger particles (this issue is an undesirable phenomenon in terms of the nanoparticles, because it reduces their reactivity), the dissolution of the nanoparticles in the solvent should be carried out in such a manner to prevent the interparticular collision during the suspension stage as much as possible. This issue can occur as a result of the creation of electrical interparticular forces and/or energy. In the above-mentioned separation process, special attention must be paid to the adsorption capacity, which is much important. This is of such a crucial importance that the process seeks to enhance the separation output through the increase in nanoparticles adsorption rather than the magnetic field. Among the superior features of this invention, one may point out to the application in high magnetic intensities as well as the decrease in the secondary effluent.

The second stage of the separation is based on the use of high magnetic gradient. This process makes it possible to separate the small particles with very low magnetic susceptibility, which is practically impossible under the routine processes. The ferromagnetic fibrous matrices are placed under a high intensity magnetic field and as a result of the dispersion of field lines, create a high magnetic gradient. The fibrous matrices are important because they provide a high effective surface. These surfaces, which make it possible to capture the magnetic particles, are so effective and are used for separation under high volumetric rates.

As the heavy metal cations present in water are diamagnetic, the use of this separation process needs for the magnetic seeding by iron oxide nanoparticles.

### BRIEF DESCRIPTION OF THE DRAWING

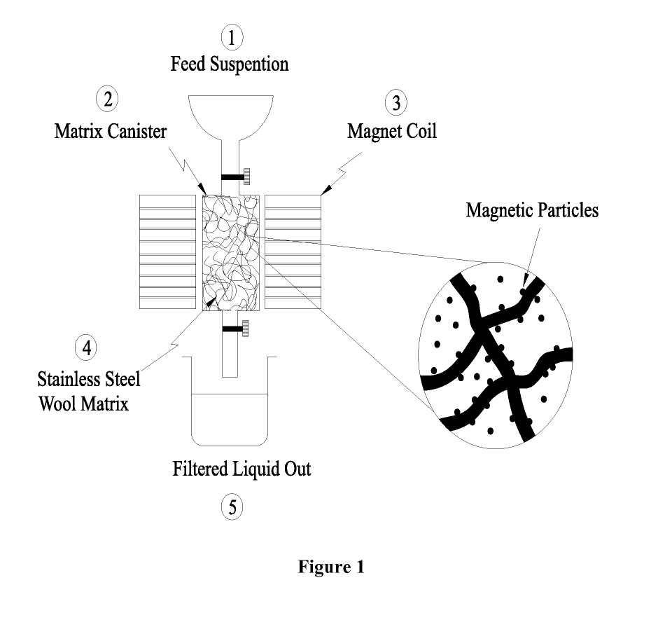

As is indicated in FIG. 1, an aqueous solution 1 containing both magnetic and non-magnetic particles enters the magnetic separator from the upper part. Within the vessel a paramagnetic matrix 2 composed of stainless steel 4 is installed which is magnetized under the application of an outside magnetic field 3. Due to the low packed density of the matrix, non-magnetic liquid and particles can easily flow through this medium 5, whereas the paramagnetic particles are effectively and with a very high yield captured by the matrix. The magnetic particles themselves are easily washed away from the matrix upon the discontinuation of the magnetic field.

The elements of this figure are:
1. Feed container, which contains iron oxide nanoparticles suspension after the adsorption process.
2. Wire matrices container
3. Electromagnets, which produce the magnetic field (perpendicular to longitude axis of container.
4. Wire matrices which deviates the magnetic field lines and causes the magnetic field gradient.
5. Tail collector, which contains the diamagnetic particles.

### DETAILED DESCRIPTION OF THE PROPOSED PROCESS

Iron oxide particles are adsorption sites of the metal cations and are used as the most important compound in the separation process. Among the three different forms of magnetic iron oxide particles, magnetite particles (Fe₃O₄) are selected as the most suitable one, mainly due to their higher magnetic susceptibility compared to the other forms (α-Fe₂O₃ and γ-Fe₂O₃).

One of the most important features of the nanoparticles, which cause the unique properties, is their very high specific surface. As a result of the very fine particle size and the porous structure of the nanoparticles, their specific surface is very high and the conservation of their small size during the metal cations adsorption process is very important. Failure to pay attention to this issue causes the agglomeration of the particles and ultimately the decrease in adsorption process output, therefore the suspension of the nanoparticles with the resulting high reactivity during the process is very important. In addition to their positive features of these nanoparticles in terms of adsorption of metal cations, there are two important limitations in their use: in the first place the magnetite nanoparticles are easily decomposed (starting from 60° C.) and secondly they must be kept away from the acid media and oxidation agents. The medium acidity makes them soluble.

Within the framework of the current tests, the nanoparticles used are magnetic and have a high propensity to aggregate and to create micron size particles. This issue concentrates on the importance of the suspension system used. It is to be mentioned that as soon as the adsorption process takes place, agglomeration and increase in particle size are considered as suitable parameters for the magnetic separation since the magnetic force imposed on the particles is in direct proportion to their size. Since the size of the particles used in these tests is on nanoscale and the ordinary suspending apparatuses are ineffective in this respect, an ultrasonic suspending device was used. The device generates ultrasonic mechanical waves to suspend the particles and to disaggregate the coarse particles, which are formed in the course of the suspension stage. Therefore care must be taken that the nanoparticles be suspended simultaneously by the action of the ultrasonic waves, in other words to achieve a solution with a given weight percentage nanoparticles should be added piecemeal and in low amounts to the aqueous solution while at the same time ultrasonic waves are scattered at the aqueous medium. This system makes the suspension time longer and at the same time provides favorable conditions for the particles to remain in suspended state.

To provide favorable condition for the adsorption of metal cations to the nanoparticles, it is mandatory that the specimens made be mixed by the shaker so as to increase the chances for the adsorption of metal cations to the nanoparticles. The efficiency of this shaking process is very important because it controls the adsorption stage efficiency and adsorption process controls the efficiency of final process. Indeed if the adsorption does not take place to a sufficient rate, the separation stage output cannot bring the process output to a significant degree.

The matrix network generates the magnetic force and the deviation of the field lines creates the magnetic field gradient and ultimately the capture of the nanoparticles from the solution. This matrix can exist in two regular and irregular forms. The matrix wires are made of stainless steel with ferromagnetic property and/or Ferro compounds like nickel and iron alloys. Among the important parameters of this matrix the diameter of matrix wires as well as their distance from each other is very important. To achieve separation adequately, it is essential that the above two parameters be as small as possible. The smaller the diameter of matrix wires, the larger will be the resulting magnetic field gradient and the magnetic force exerted on the nanoparticles. The small distance of the matrix wires makes it possible that the matrix wires capture a greater percentage of the nanoparticles. Since the capture of the nanoparticles by the matrix will decrease its efficiency when reused, after each test the matrix must be washed thoroughly. In consideration of the irregular shape of the matrix network in this set of tests, the substitution of the new network while the tests are conducted will decrease the accuracy of the results which is due to the fact that the new form of the matrix will change the gradient and the force exerted on the nanoparticles whereas the use of a single matrix shape will stabilize the packed density coefficient for all cases and therefore will provide uniform conditions in all experiments.

To select the aqueous medium, distilled and deionized water are two suggested options. In consideration of the fact that distilled water composition is more like the true aqueous medium and makes it possible to achieve a more realistic analysis, the distilled water has been used. In addition it is mandatory that all tests be conducted in a medium with fixed ionic strength. To consider this issue, a suitable salt must be dissolved in the aqueous medium to be tested. The salt selected for this purpose is sodium nitrate. The high ionic strength of this salt as well as its remarkable buffering capacity in the solution (which is useful for controlling pH), are two favorable important reasons of the use of this salt.

Furthermore, lead nitrate, copper nitrate and cadmium nitrate were used for producing metal cations (due to the high ionic strength of the above salts) whereas nitric acid and caustic soda were used to adjust the medium pH.

### EXAMPLES

### Example 1

As a result of adsorption of metal cations to the nanoparticles, strong bonds between the metal cations and iron oxide will form which makes it quite difficult to separate them. Indeed, this is a positive parameter for the separation since the ordinary modifications in the effective parameters do not cause the separation of the metal cations from the iron oxide molecules. However this issue is considered a negative point in terms of nanoparticles recycling. The first step in the adsorption tests is the determination of an appropriate limit for pH which itself is a key parameter in the adsorption process and any modification thereof will alter the adsorption degree (due to the change of separation mechanism).

The results of the adsorption tests are sensitive to pH and any change thereof will bring about a considerable change in adsorption. Any increase in system pH will cause in the sedimentation of metal cations in the form of hydroxide and will make it impossible for the adsorption to take place. Furthermore, the adsorption process requires a longer time compared to the alkaline sedimentation and therefore the increase in pH results in the increasing superiority of the sedimentation mechanism in comparison to the adsorption and the decrease in the adsorption of the metal cations to the nanoparticles.

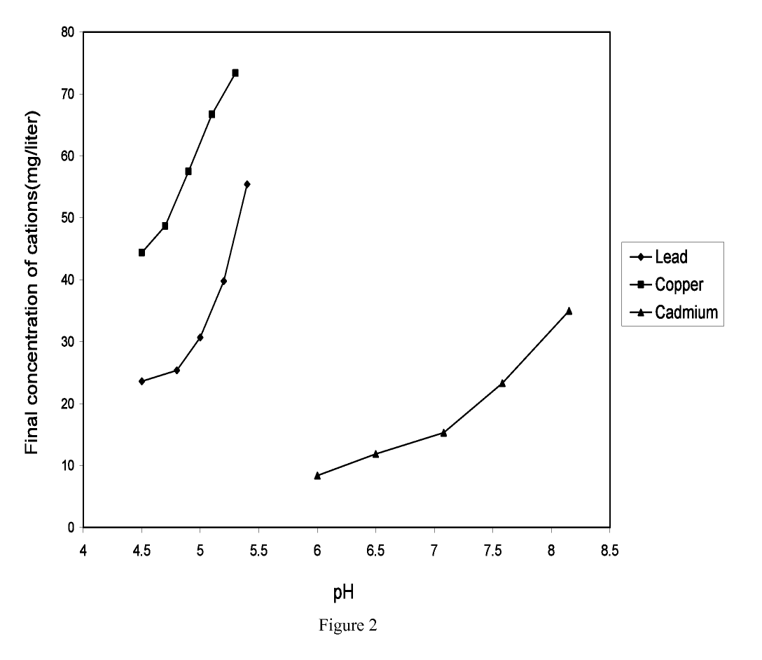

However as the excessive increase of pH ends up with the sedimentation of the metal cations in hydroxide form and makes it impossible for the adsorption to take place, the excessive decrease in ambient pH causes with the dissolution of nanoparticles in the aqueous medium and their lower efficiency as sites for the adsorption of metal cations. Therefore the precise pH limits where the three selected metals will remain in cationic form and the adsorption takes place adequately is of crucial importance. The other issue, which is worth mentioning, is the nanoparticle's Zeta charge potential or in other words the electrical hindrance of the surface of these nanoparticles in terms of the cations adsorption. When the ambient pH is less than a certain limit, the hydronium ion (H⁺) will increase in the medium and this will cause with the positive charge potential of the particles and as a result of the electrostatic hindrance, the medium will be unfavorable to the adsorption of metal cations. These issues all point to the importance of controlling system pH as a primary requirement to conduct tests. Special attention must be paid to all factors affecting the adsorption process because the range of the suitable pH is very narrow: 4.4-5.7 for lead cations, 4.4-5.4 for copper cations and 4.4 to 8.4 for cadmium cations. The results of adsorption of heavy metal cations are tabulated through tables 1-3 and presented by FIG. 2.

TABLE 1
Results of adsorption of lead cations for different pH

| Final | | | | | Mass |
|---|---|---|---|---|---|
| concentration | | | | Initial | percentage |
| of lead | Contact | | | concentration | of |
| cations | time | Temperature | | of lead cations | particles |
| (mg/liter) | (hours) | (° C.) | PH | (mg/liter) | (gr/liter) |
| 23.6 | 2.5 | 25 | 4.5 | 400 | 2 |
| 25.4 | 2.5 | 25 | 4.8 | 400 | 2 |
| 30.7 | 2.5 | 25 | 5 | 400 | 2 |
| 39.8 | 2.5 | 25 | 5.2 | 400 | 2 |
| 55.4 | 2.5 | 25 | 5.4 | 400 | 2 |

TABLE 2
Results of adsorption of copper cations for different pH

| Final | | | | Initial | Mass |
|---|---|---|---|---|---|
| concentration | | | | concentration | percentage |
| of copper | Contact | | | of copper | of |
| cations | time | Temperature | | cations | particles |
| (mg/liter) | (hours) | (° C.) | PH | (mg/liter) | (gr/liter) |
| 44.4 | 2.5 | 25 | 4.5 | 400 | 2 |
| 48.7 | 2.5 | 25 | 4.7 | 400 | 2 |
| 57.5 | 2.5 | 25 | 4.9 | 400 | 2 |
| 66.7 | 2.5 | 25 | 5.1 | 400 | 2 |
| 73.4 | 2.5 | 25 | 5.3 | 400 | 2 |

TABLE 3
Results of adsorption of cadmium cations for different pH

| Final | | | | Initial | |
|---|---|---|---|---|---|
| concentration | | | | concentration | Mass |
| of cadmium | Contact | Temp- | | of cadmium | percentage |
| cations | time | erature | | cations | of particles |
| (mg/liter) | (hours) | (° C.) | pH | (mg/liter) | (gr/liter) |
| 8.4 | 2.5 | 25 | 6 | 400 | 2 |
| 11.9 | 2.5 | 25 | 6.5 | 400 | 2 |
| 15.3 | 2.5 | 25 | 7.08 | 400 | 2 |
| 23.3 | 2.5 | 25 | 7.58 | 400 | 2 |
| 35 | 2.5 | 25 | 8.15 | 400 | 2 |

With the increase in pH, the rate of metal cations adsorption to the nanoparticles will decrease. The slope of this decrease is steeper in the upper limit of pH, because as we approach the higher limit, more favorable conditions to the alkaline sedimentation will occur and to the same extent the ability of the nanoparticles to adsorb the metal cations will decrease. In consideration of the results obtained through the tests, the lower pH limit (4.5 for lead and copper and 6 for cadmium) is the most suitable limit to conduct the adsorption tests, therefore in the continuation of the tests and for considering the parameters affecting the separation rate we will select it as the media pH.

### Example 2

TABLE 4
Adsorption results of heavy metal cations at different percentage of nanoparticles

| Cadmium | Copper cations | Lead cations | | | | Nanoparrticles |
|---|---|---|---|---|---|---|
| cations final | final | final | Contact | | Cations initial | mass |
| concentration | concentration | concentration | Time | Temperature | concentration | percentage |
| (mg/liter) | (mg/liter) | (mg/liter) | (hours) | (° C.) | (mg/liter) | (gr/liter) |
| 45.5 | 68.5 | 59.8 | 2.5 | 25 | 400 | 1 |
| 12.7 | 44.4 | 21.7 | 2.5 | 25 | 400 | 2 |
| 6.5 | 27.3 | 9.2 | 2.5 | 25 | 400 | 3 |
| 2.4 | 15.2 | 5.3 | 2.5 | 25 | 400 | 4 |
| 0.2 | 4.9 | 1.9 | 2.5 | 25 | 400 | 5 |

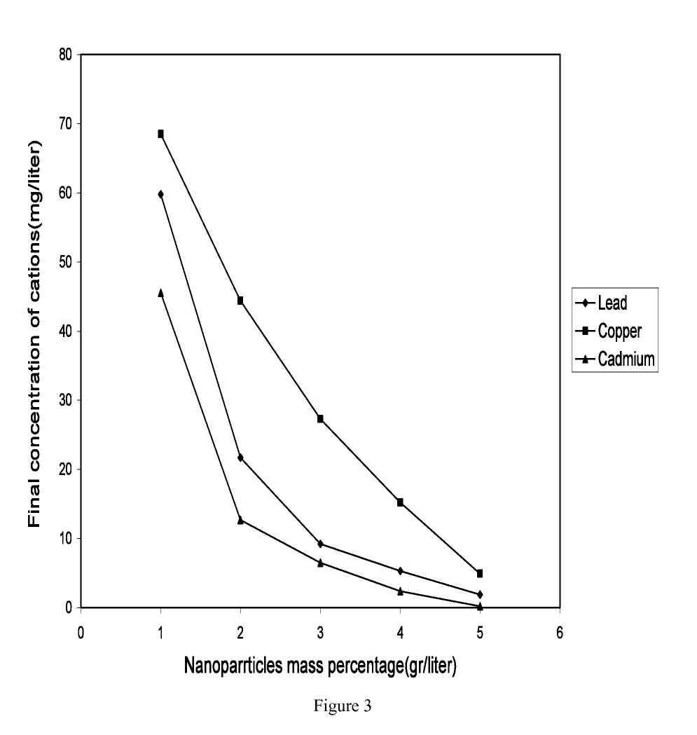

Table 4 and FIG. 3 contain the adsorption results of heavy metal cations to nanoparticles when the mass percentage of nanoparticles is different.

Based on the results, it becomes clear that any increase in the nanoparticles mass percentage will increase the metal cations adsorption rate. In addition to the increase in the number of adsorbent sites, the increase in the probability of collision of nanoparticles with the metal cations increases the adsorption rate. On the other hand, the increase in the nanoparticles mass percentage will decrease the adsorption rate of the metal cations per nanoparticles mass unit, because the increase of the adsorbent sites will discard the necessity of the placement of the cations on the adsorbent sites and this will decrease the cations adsorption density per adsorption surface unit.

### Example 3

TABLE 5
The results of adsorption of heavy metal cations for different initial concentrations

| Cadmium | Copper cations | Lead cations | | | | Nanoparticles |
|---|---|---|---|---|---|---|
| cations final | final | final | Contact | | Cations initial | mass |
| concentration | concentration | concentration | Time | Temperature | concentration | percentage |
| (mg/liter) | (mg/liter) | (mg/liter) | (hours) | (° C.) | (mg/liter) | (gr/liter) |
| 1.7 | 8.5 | 3.4 | 2.5 | 25 | 100 | 2 |
| 6.8 | 19.6 | 11.3 | 2.5 | 25 | 200 | 2 |
| 10.6 | 29.8 | 17.3 | 2.5 | 25 | 300 | 2 |
| 16.9 | 43.8 | 25.6 | 2.5 | 25 | 400 | 2 |
| 28.3 | 58.9 | 34.6 | 2.5 | 25 | 500 | 2 |

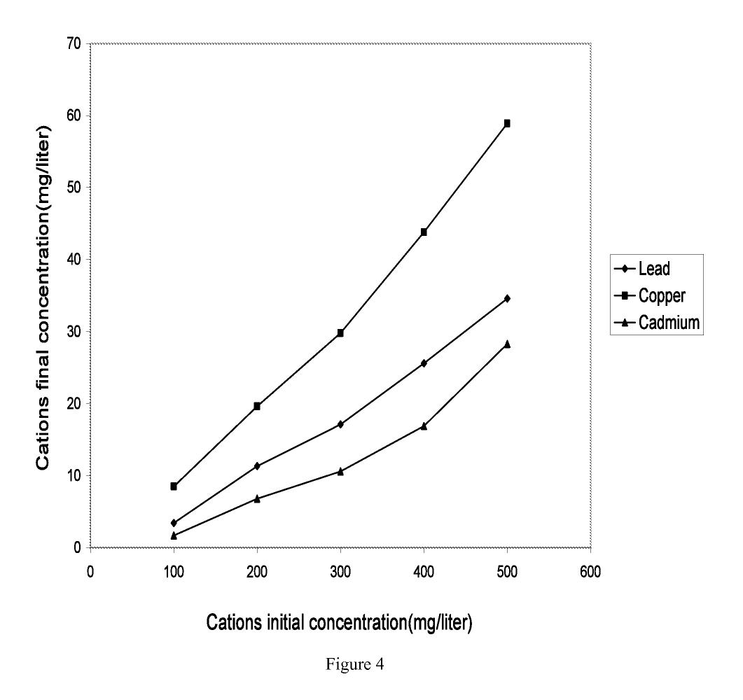

The results of adsorption of heavy metal cations for different their initial concentrations can be found in table 5 and FIG. 4.

Despite the fact that it may seem contradictory, the increase in the concentration will increase the adsorption rate of metal cations by nanoparticles as the specific surface of the nanoparticles is high (60 square meters per gram) and the increase in the metal cations concentration does not limit the adsorption rate but will increase the probability of the collision of the cations to the nanoparticles and therefore the adsorption will improve as a result of higher collisions. The slope of this increase is steeper in the lower concentrations as the increase in concentration will increase the adsorption rate and therefore more adsorbent sites are occupied by the metal cations and this will in turn decrease to some extent the tendency of the nanoparticles to adsorb the remaining metal cations.

### Example 4

TABLE 6
Effect of contact time on the results of adsorption experiments

| Cadmium | Copper cations | Lead cations | | | | Nanoparticles |
|---|---|---|---|---|---|---|
| cations final | final | final | Contact | | Cations initial | mass |
| concentration | concentration | concentration | Time | Temperature | concentration | percentage |
| (mg/liter) | (mg/liter) | (mg/liter) | (minutes) | (° C.) | (mg/liter) | (gr/liter) |
| 18.5 | 56.8 | 33.2 | 15 | 25 | 400 | 2 |
| 14.4 | 51.2 | 29.9 | 30 | 25 | 400 | 2 |
| 12.5 | 49.7 | 26.8 | 45 | 25 | 400 | 2 |
| 11.3 | 48.6 | 25.9 | 60 | 25 | 400 | 2 |
| 10.3 | 47.2 | 25 | 75 | 25 | 400 | 2 |

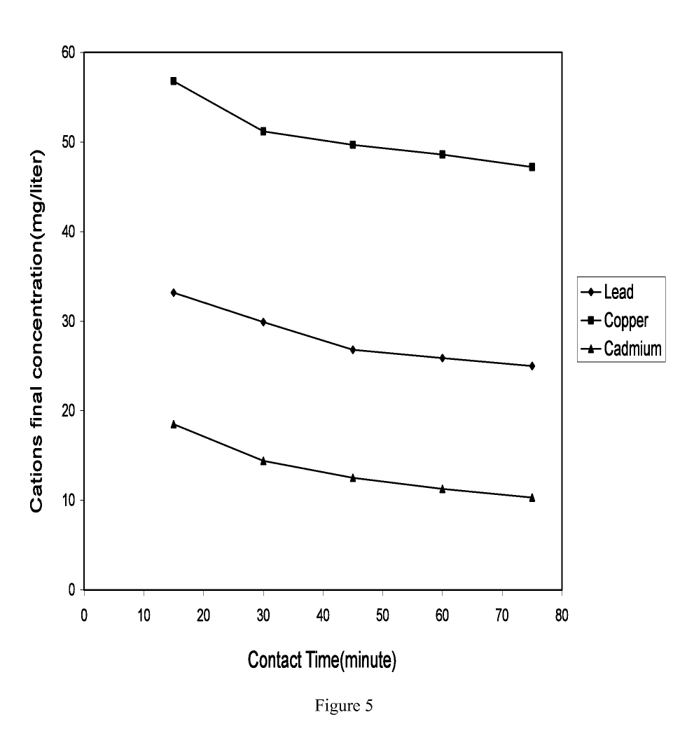

The effect of contact time on the results of adsorption is presented through table 6 and FIG. 5.

The test results indicate that a considerable percentage of the total metal cations are adsorbed at the initial moments (first 15 minutes). Therefore, the contact time does not have a significant effect on the adsorption process of the three metal cations by the iron oxide nanoparticles.

### Example 5

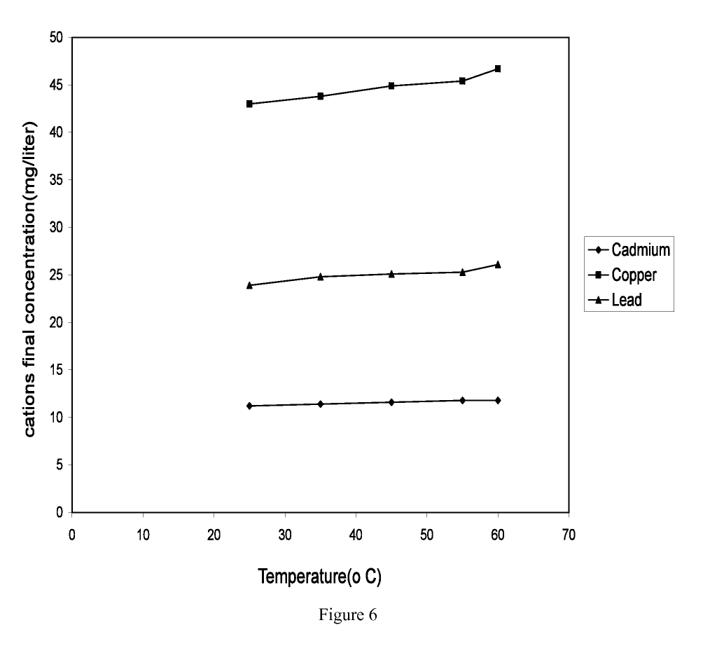

Table 7 and FIG. 6 contain the results of adsorption for different temperature.

Within the framework of the tests designed to this effect, the temperature gradient varies from 25 to 60° C. because the iron oxide nanoparticles are decomposed at temperatures above 64° C. and not suitable for metal cations.

TABLE 7
Results of adsorption experiments for different temperature

| Cadmium | Copper cations | Lead cations | | | | Nanoparticles |
|---|---|---|---|---|---|---|
| cations final | final | final | Contact | | Cations initial | mass |
| concentration | concentration | concentration | Time | Temperature | concentration | percentage |
| (mg/liter) | (mg/liter) | (mg/liter) | (hours) | (° C.) | (mg/liter) | (gr/liter) |
| 11.2 | 43 | 23.9 | 2.5 | 25 | 400 | 2 |
| 11.4 | 43.8 | 24.8 | 2.5 | 35 | 400 | 2 |
| 11.6 | 44.9 | 25.1 | 2.5 | 45 | 400 | 2 |
| 11.8 | 45.4 | 25.3 | 2.5 | 55 | 400 | 2 |
| 11.8 | 46.7 | 26.1 | 2.5 | 60 | 400 | 2 |

With the temperature rise from 25° to 60° C., the adsorption rate of three metal cations is decreased very insignificantly. This issue is attributed to the tendency of the metal cations to get free from the nanoparticles surface and to enter to the fluid bulk. Overally it can be stated the effect of temperature on the metal cations adsorption is not noticeable.

### Example 6

In the second stage, the ferromagnetic matrix captures the nanoparticles by the application of a foreign magnetic field. Since the nanoparticles are separated from the solution in this stage the study of this stage and the factors affecting is very important. It is worth mentioning that all the factors, which were referred to in the previous section, are affecting this stage too.

Within the framework of the current set of tests, the nanoparticles used are superpara-magnetic in character therefore they are magnetized and lose their magnetism very rapidly. This property is due to the very fine and minute dimensions of the nanoparticles (the nanodimensions aggravate their paramagnetic character very much) and as a result of which the nanoparticles are captured with a high efficiency by the wires of a ferromagnetic matrix (or a paramagnetic matrix magnetized by a foreign magnetic field) and therefore there is no need to a very high magnetic field. On the other hand, the nanoparticles are easily captured by the magnetized matrix and this issue will make their application in magnetic separation very interesting, because their magnetic behavior is easily controlled to such an extent that upon the adsorption of the metal cations by these particles they can be set with a small magnetic field on the matrix effectively. However upon the discontinuation of the magnetic field they easily lose their magnetic character and are separated from the matrix, which makes it possible the washing of the matrices and their use for extended period.

In these experiments, the metal cations used are diamagnetic in character and their adsorption to the nanoparticles reduces the super paramagnetic character of the latter, therefore all the factors, which increase the yield of the adsorption process affect the yield of this stage negatively and vice versa. However this issue is not so important to adversely affect the separation process.

The increase in the exposure time of the nanoparticles to the magnetic field does not affect the rate of separation and is not considered an affecting factor within this context. This issue can be attributed to the super paramagnetic nature of the said nanoparaticles as a result of which the particles are intensely magnetized as soon as the magnetic field is established and the period of exposure does not affect their susceptibility rate, therefore the magnetic separation requires a much shorter time compared to the adsorption process (a fraction of a second).

The intensity of magnetic field in the all-second stage tests (except the effect of the magnetic field) has been equivalent to 0.5 Tesla. For the study of the magnetic field the intensity varies between 0.1 to 0.5 Tesla.

The results of the above tests indicate that the second stage takes place with a high rate and under an approximate 100% yield and none of the selected parameters affect the yield of this stage to a significant rate. This is to say that the total separation process yield is equal to that of the adsorption stage.

While the invention is described through the above examples, it will be understood by those of ordinary skill in the art that modification to and variation of the illustrated embodiment may be made without departing from the inventive concepts herein disclosed.

Accordingly, the invention should not be viewed as limited except by the scope and spirit of the appended claims.

What is claimed is:

1. A method for extracting a predetermined amount of heavy metal cations from an aqueous medium consisting: adding a predetermined amount of Nanoparticles to said aqueous medium wherein said aqueous medium is contaminated with said predetermined amount heavy metal cations;
Impregnating said predetermined amount of Nanoparticles with said predetermined amount of heavy metal cations to obtain a predetermined amount of impregnated nanoparticles;
Magnetizing said predetermined amount of impregnated nanoparticles; and
Extracting said predetermined amount of heavy metal cations from said aqueous medium.

2. The method as claimed in claim 1, wherein said nanoparticles are iron oxides (Fe₃O₄).

3. The method as claimed in claim 1, wherein said magnetizing is performed by a ferromagnetic matrix (or a paramagnetic matrix) and employs an outside magnetic field, and comprises capturing efficiency by a high gradient magnetic separation method.

4. The method as claimed in claim 1, wherein said nanoparticles are selected from a group consisting of Fe₃O₄, Fe₂O₃.

5. The method as claimed in claim 1, wherein said impregnating takes place by ion exchange.

6. The method of claim 1, wherein any increase in weight percentage of said nanoparticles, initial concentration of said predetermined amount of heavy metal cations, and duration time for impregnation causes an augment in amount of cations extraction.

7. The method of claim 1, wherein any augment in pH and temperature of said aqueous medium decreases amount of heavy metal cations extraction from said aqueous medium.

8. The method of claim 1, wherein said extracting has an efficiency factor and said factor depends solely on said impregnating.

9. The method of claim 1, wherein said extracted predetermined amount of heavy metal cations from said aqueous medium is equal to said heavy metal cations impregnating said of Nanoparticles.
